(19) United States
(12) Patent Application Publication
(10) Pub. No.: US 2026/0074136 A1
(43) Pub. Date: Mar. 12, 2026

(54) UNSEALED SINGLE FUSE HOLDER

(71) Applicant: Littelfuse, Inc., Rosemont, IL (US)

(72) Inventors: Andrew Jozwiak, San Antonio, TX (US); Jesus Roberto Morales, Juarez (MX)

(73) Assignee: Littelfuse, Inc., Rosemont, IL (US)

(21) Appl. No.: 19/391,098

(22) Filed: Nov. 17, 2025

Related U.S. Application Data
(62) Division of application No. 18/370,978, filed on Sep. 21, 2023, now Pat. No. 12,500,057.
Application No. 18/370,978 is a continuation of application No. 17/942,575, filed on Sep. 12, 2022, now Pat. No. 11,817,284.

(51) Int. Cl. H01H 85/20; H01H 85/22

(52) U.S. Cl. CPC H01H 85/205; H01H 2085/2055; H01H 2085/2075; H01H 85/22

(57) ABSTRACT

A fuse holder includes a movable tab, a base, and a cover. A stud is affixed to the movable tab and secures a terminal of a bolt-down fuse. A second stud is affixed to the base and secures a second terminal of the bolt-down fuse. The base has a channel into which the movable tab is slidably inserted. The cover connects to the base and is located over the stud and the second stud.

### Related Applications

This application is a divisional of U.S. Application Serial No. 18/370,978, filed September 21, 2023, which is a continuation of U.S. Application Serial No. 17/942,575, filed September 12, 2022, now granted as U.S. Patent 11,817,284, entitled " UNSEALED SINGLE FUSE HOLDER," the entirety of which applications are incorporated by reference herein for all purposes.

### Field of the Disclosure

Embodiments of the present disclosure relate to fuse holders and, more particularly, to a fuse holder for linear bolt-down fuses.

### Background

Linear bolt-down fuses are characterized as having a fuse housing disposed between two terminals, with the fuse housing and the two terminals being lined up with one another. The terminals each have apertures for receiving a stud. Typically secured with a nut, each stud attaches the terminal to either a cable (via a ring terminal) or to a busbar. A fuse within the fuse housing is thus electrically connected between two cables, a cable and a busbar, or two busbars.

Often, multiple bolt-down fuses may be used, such as inside a vehicle. With each bolt-down fuse being coupled to two cables, the cabling may become tangled or multiple cables may need to be zip-tied together. Some of the bolt-down fuses may be attached to a busbar at one end, but the busbar may not have enough apertures to accept all the bolt-down fuses. Although the fuse housing protects the fuse therein, the external studs and terminals may be exposed to elements or risk being shorted with other circuit elements. Further, the ends of the bolt-down fuse need to be supported to not flex the fuse terminals and fuse element inside the housing.

It is with respect to these and other considerations that the present improvements may be useful.

### Summary

This Summary is provided to introduce a selection of concepts in a simplified form that are further described below in the Detailed Description. This Summary is not intended to identify key or essential features of the claimed subject matter, nor is it intended as an aid in determining the scope of the claimed subject matter.

An exemplary embodiment of a fuse holder in accordance with the present disclosure may include a movable tab, a base, and a cover. A stud is affixed to the movable tab and secures a terminal of a bolt-down fuse. A second stud is affixed to the base and secures a second terminal of the bolt-down fuse. The base has a channel into which the movable tab is slidably inserted. The cover connects to the base and is located over the stud and the second stud.

An exemplary embodiment of a fuse holder assembly in accordance with the present disclosure may include a first fuse holder and a second fuse holder. The first fuse holder has a movable tab with a stud and a base. The base has a channel for receiving the movable tab and a pair of dovetail connectors located on a first side of the base. The second fuse holder also has a movable tab with a stud and a base. The base of the second fuse holder has a channel for receiving the movable tab and a pair of openings disposed on a second side. The pair of dovetail connectors of the first fuse holder fit into the pair of openings of the second fuse holder.

### Brief Description of the Drawings

FIGS. 1A-1C are diagrams illustrating a fuse holder, in accordance with exemplary embodiments;

FIGS. 2A-2C are diagrams illustrating examples of fuses suitable for use in the fuse holder of FIGS. 1A-1C, in accordance with exemplary embodiments;

FIG. 3 is a diagram illustrating the fuse holder of FIGS. 1A-1C, in accordance with exemplary embodiments;

FIGS. 4A-4E are diagrams illustrating the base of the fuse holder of FIG. 1A, in accordance with exemplary embodiments;

FIGS. 5A-5E are diagrams illustrating the base of the fuse holder of FIGS. 1B-1C, in accordance with exemplary embodiments;

FIGS. 6A-6D are diagrams illustrating the movable tab of the fuse holders of FIG. 1A, in accordance with exemplary embodiments;

FIGS. 7A-7D are diagrams illustrating the movable tab of the fuse holder of FIGS. 1B-1C, in accordance with exemplary embodiments;

FIGS. 8A-8D are diagrams illustrating the cover of the fuse holders of FIGS. 1A-1C, in accordance with exemplary embodiments;

FIGS. 9A-9D are diagrams illustrating the first mounting tab of the fuse holder of FIGS. 1A-1C, in accordance with exemplary embodiments;

FIGS. 10A-10D are diagrams illustrating the second mounting tab of the fuse holder of FIGS. 1A-1C, in accordance with exemplary embodiments;

FIG. 11 is a diagram illustrating a busbar of the fuse holder of FIGS. 1A-1C, in accordance with exemplary embodiments; and

FIGS. 12A-12E are diagrams illustrating the fuse holder of FIGS. 1A-1C in stacked configurations, in accordance with exemplary embodiments.

### DETAILED DESCRIPTION

A fuse holder and fuse holder assembly are disclosed. The fuse holder has a base with a channel and a stud affixed at one end. A movable tab has a second stud affixed thereto. The movable tab slidably fits into the channel and the channel includes elements for securing the movable tab in place. Because of the movable tab, the fuse holder can support bolt-down fuses having various distances between terminal apertures, as the second stud can be moved to accommodate the fuse length. The base has features on either side that allow one or more mounting tabs to be attached to the fuse holder. The features also allow the fuse holder to be attached to other fuse holders. The resulting fuse holder assemblies can support different bolt-down fuses having different sizes and voltage ratings. The fuse holder assemblies can include busbars to reduce the attached cabling.

For the sake of convenience and clarity, terms such as “top”, “bottom”, “upper”, “lower”, “vertical”, “horizontal”, “lateral”, “transverse”, “radial”, “inner”, “outer”, “left”, and “right” may be used herein to describe the relative placement and orientation of the features and components, each with respect to the geometry and orientation of other features and components appearing in the perspective, exploded perspective, and cross-sectional views provided herein. Said terminology is not intended to be limiting and includes the words specifically mentioned, derivatives therein, and words of similar import.

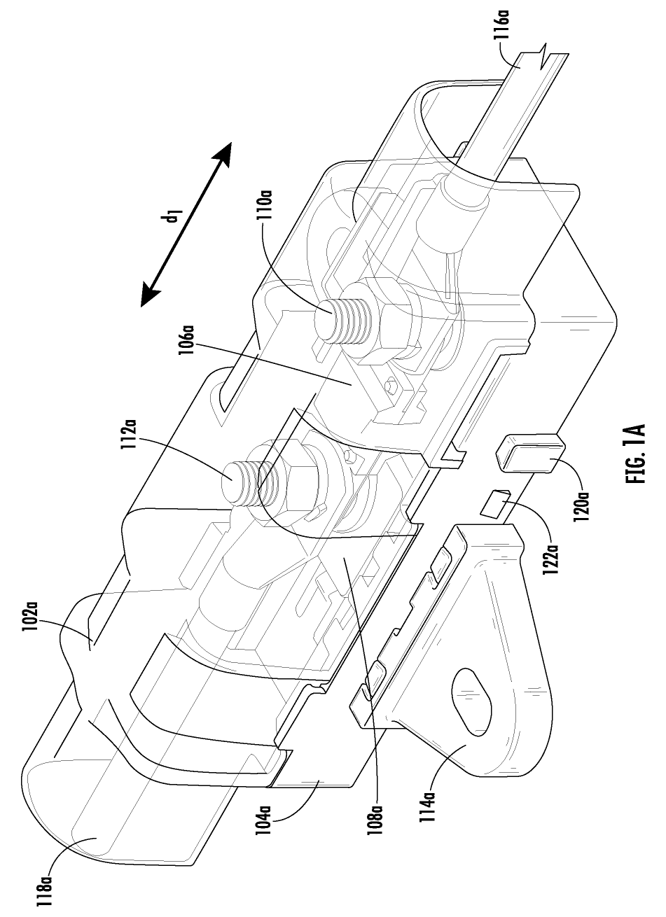

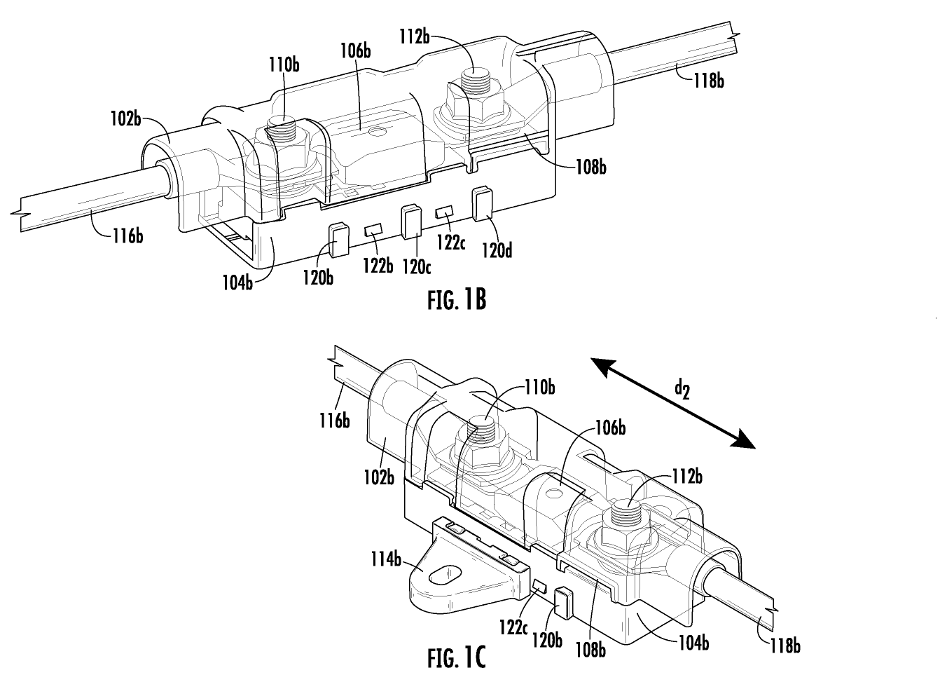

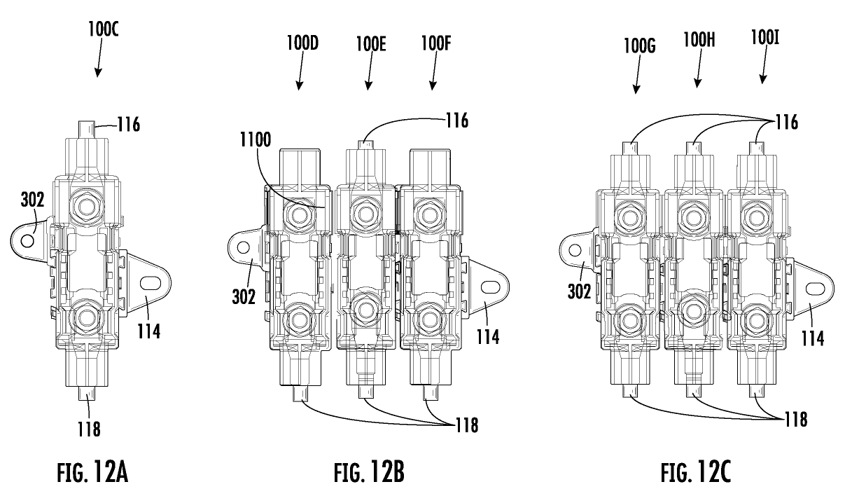

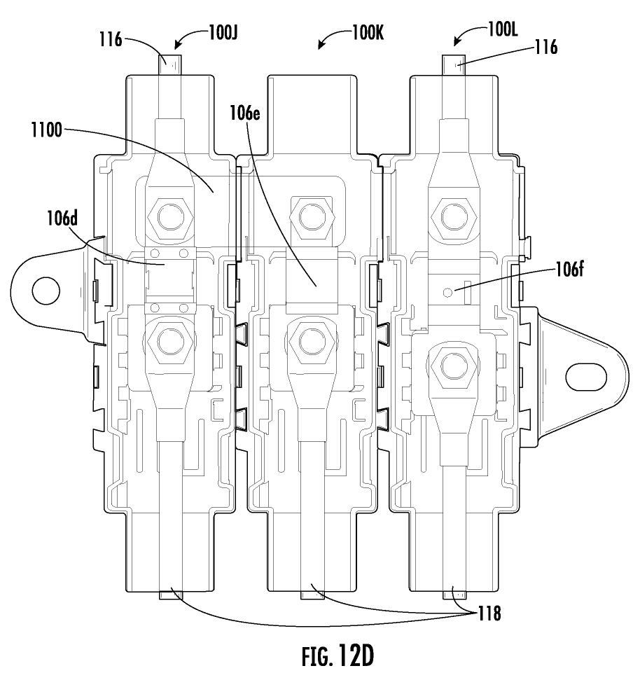

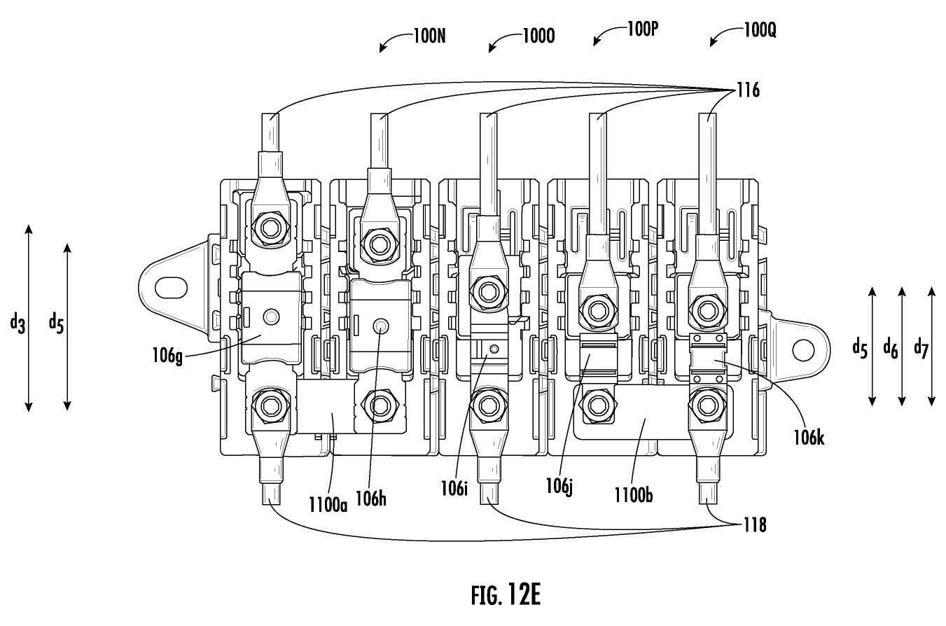

FIGS. 1A-1C are representative drawings of fuse holders 100 for securing bolt-down fuses, according to exemplary embodiments. FIG. 1A is a perspective view of a first fuse holder 100A and FIGS. 1B-1C are perspective views of a second fuse holder 100B (collectively, “fuse holder(s) 100”). Fuse holder 100A includes a cover 102a, a base 104a, a movable tab 108a, and, optionally, a mounting tab 114a; fuse holder 100B includes a cover 102b, a base 104b, a movable tab 108b, and, optionally, a mounting tab 114b (collectively, “cover(s) 102”, “base(s) 104”, “moveable tab(s) 108”, and “mounting tab(s) 114”). The fuse holder 100A provides protection for a fuse 106a that is secured by both a fixed stud 110a connected to a cable 116a and a movable stud 112a connected to a cable 118a, where the movable stud is mounted to the movable tab 108a; similarly, the fuse holder 100B provides protection for a fuse 106b that is secured by both a fixed stud 110b connected to a cable 116b and a movable stud 112b connected to a cable 118b, where the movable stud is mounted to the movable tab 108b (collectively, “fuse(s) 106”, “fixed stud(s) 110”, “movable stud(s) 112”, “cable(s) 116” and “cable(s) 118”). Alternatively, one or both studs 110 and 112 may be connected to a busbar rather than a cable, such as when multiple fuse holders 100 are stacked together. Examples of such stacked configurations are shown in FIGS. 12B-12E, below.

In exemplary embodiments, the fixed stud 110a and the movable stud 112a of the fuse holder 100A are M6 studs while the fixed stud 110b and the movable stud 112b of the fuse holder 100B are M8 studs. In other embodiments, the fuse holders 100A and 100B are adapted to support M4 studs, M5 studs, and studs of other dimensions, as the size of the stud is not meant to be limiting. In exemplary embodiments, the fuse holder 100 may be adapted to accommodate different stud sizes.

As will be shown herein, the fuse holders 100A and 100B are designed to be used with a variety of different types of linear, bolt-down fuses. FIGS. 2A-2C are representative drawings of three bolt-down fuses 106a-c, which are suitable for use in the fuse holders 100A or 100B. FIG. 2A shows a MEGA bolt-down fuse 106a; FIG. 2B shows a MIDI bolt-down fuse 106b; and FIG. 2C shows an EV1 bolt-down fuse 106c. Fuse 106a features a fuse housing 202a, a terminal 204a having a stud aperture 208a, and a terminal 206a having a stud aperture 210a. Fuse 106b features a fuse housing 202b, a terminal 204b having a stud aperture 208b, and a terminal 206b having a stud aperture 210b. Fuse 106c features a fuse housing 202c, a terminal 204c having a stud aperture 208c, and a terminal 206c having a stud aperture 210c (collectively, “fuse housing 202”, “terminal(s) 204”, “terminal(s) 206”, “stud aperture(s) 208”, and “stud aperture(s) 210”). For purposes of describing the fuse holder 100, a bolt-down fuse is thus defined herein as a fuse having a first terminal 204 with a stud aperture 208 and a second terminal 206 also with a stud aperture 210, where the fuse housing 202 is linearly aligned between the first terminal and the second terminal. The fuses 106a-c of FIGS. 2A-2C are known as bolt-down fuses because studs are inserted through the stud apertures to bolt the fuses to either a cable (typically having a ring terminal on its end), to a busbar, or to both a cable and busbar.

The fuses 106 suitable for the fuse holder 100 may vary in size and voltage rating. In exemplary embodiments, the fuse holder 100 secures different sizes and types of bolt-down fuses. Returning to FIGS. 1A and 1C, the fixed stud 110a is a distance, d 1, from the movable stud 112a in the fuse holder 100A while the fixed stud 110b is a distance, d 2, from the movable stud 112b in the fuse holder 100B, where d 1 ≠ d 2. This means that the distance between stud apertures of the two terminals of the fuse 106a is different from that of the fuse 106b. In exemplary embodiments, the fuse holder 100 is designed to accommodate different stud aperture distances. The fuse holder 100 is also designed to accommodate different fuse centerlines.

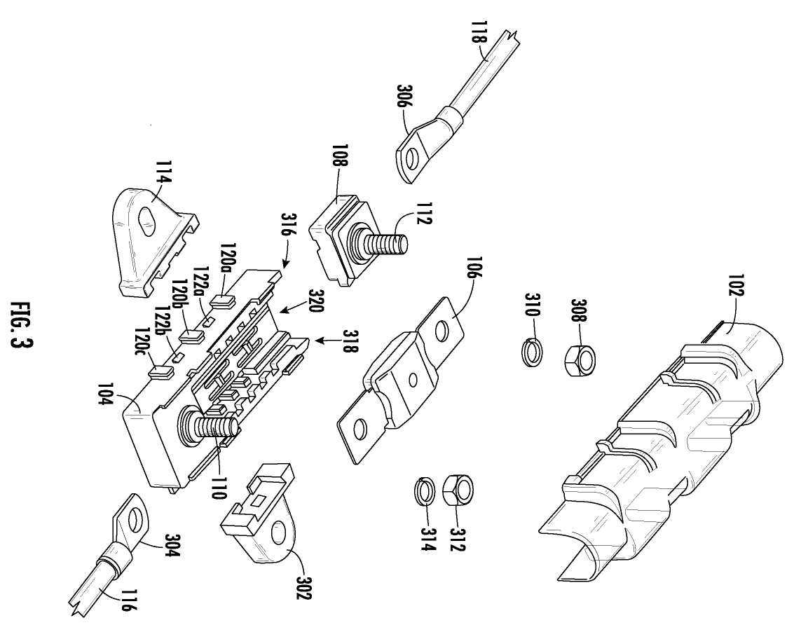

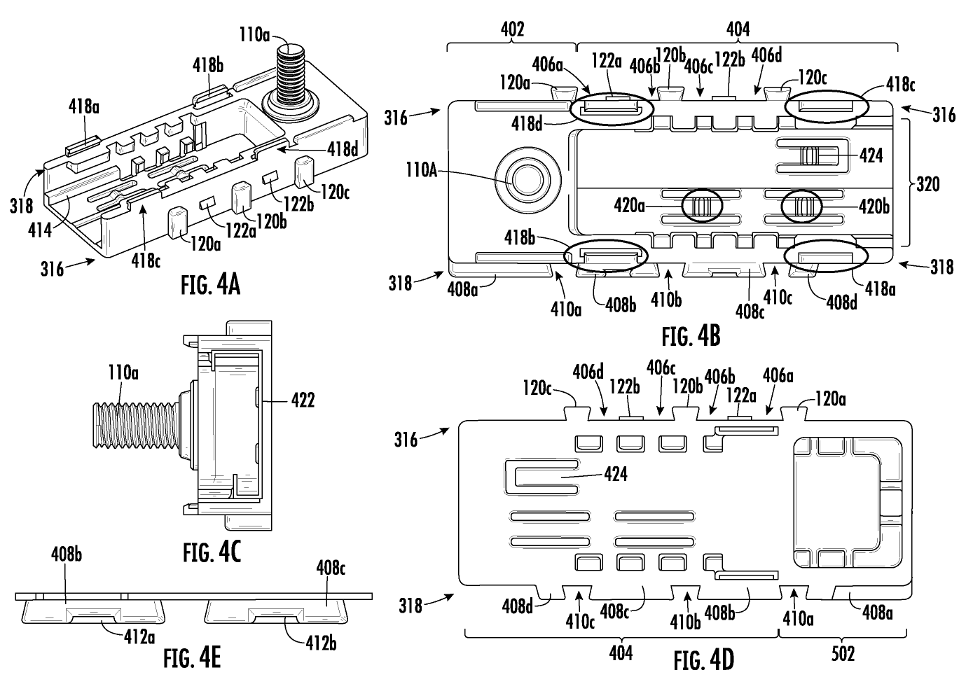

In exemplary embodiments, the base 104 of the fuse holder 100 includes features both for affixing the optional mounting tab 114 and for stacking multiple fuse holders next to one another. Dovetail connector 120a and lock ramps 122a are shown on the base 104a of fuse holder 100A (FIG. 1A) while dovetail connectors 120b, 120c, and 120d and lock ramps 122b and 122c are shown on the base 104b of fuse holder 100B (FIG. 1C) (collectively, “dovetail connector(s) 120” and “lock ramp(s) 122”). The dovetail connectors 120 and lock ramps 122 are described in more detail in the description of FIGS. 4A-4D, 5A-5D, 9A-9D, and 10A-10D, below.

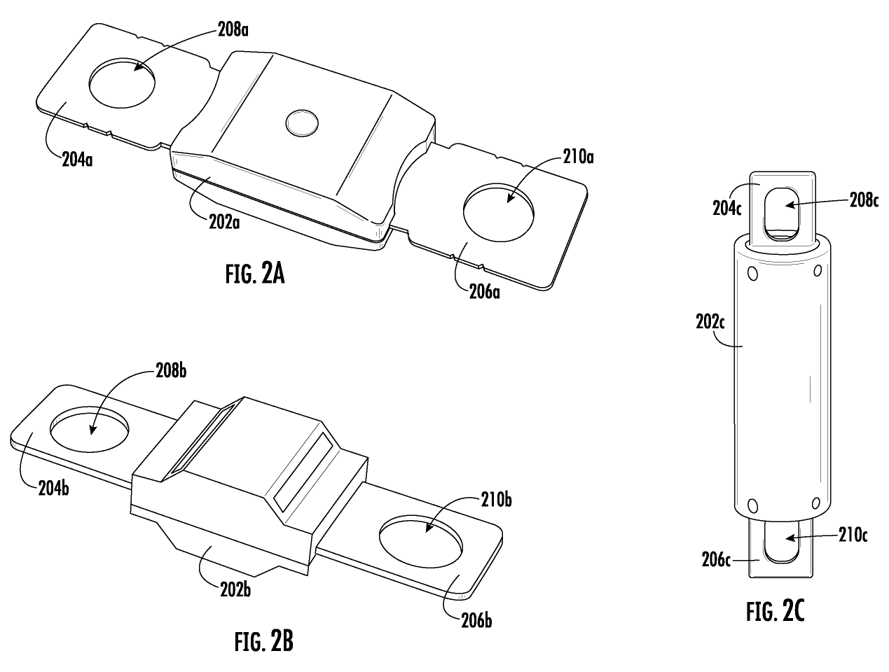

FIG. 3 is a representative exploded view of the fuse holder 100, according to exemplary embodiments. The cover 102, the base 104, the movable tab 108, the fixed stud 110, the movable stud 112, and the optional mounting tab 114 of the fuse holder 100 are shown as before. Additionally, the fuse 106 to be disposed inside the fuse holder 100, the cable 116, and the cable 118 are shown. Dovetail connectors 120a-120c and lock ramps 122a-b are shown, with lock ramp 122a being between dovetail connector 120a and 120b and lock ramp 122b being between dovetail connector 120b and 120c.

The movable stud 112 is disposed upon the movable tab 108. Cable 116 includes ring terminal 304 and cable 118 includes ring terminal 306. Once the movable tab 108 is in position inside the base 104, the terminals of the fuse 106 are placed over the fixed stud 110 and the movable stud 112. The ring terminal 304 of cable 116 is then placed over the fixed stud 110 while the ring terminal 306 of the cable 118 is placed over the movable stud 112. An optional washer 310 is placed over the movable stud 112 and a nut 308 is threaded over the stud to secure the assembly on one side of the fuse 106. An optional washer 314 is placed over the fixed stud 110 and a nut 312 threaded over the stud to secure the assembly on the other side of the fuse 106.

The base 104 has a side 316 and a side 318. In exemplary embodiments, the side 316 is different from the side 318. A second optional mounting tab 302 is shown. The dovetail connectors 120 and lock ramps 122 on the side 316 of the base 104 are used to secure the mounting tab 114 while dovetail connectors (not shown) on the side 318 of the base are used to secure the mounting tab 302. In exemplary embodiments, the mounting tab 114 is configured differently than the mounting tab 302, as the side 316 of the base 104 is different from the side 318. Thus, the mounting tab 114 is designed to be attached to the side 316 while the mounting tab 302 is designed to be attached to the side 318 of the base. In exemplary embodiments, the cover 102, the base 104, the mounting tab 114, and the mounting tab 302 are made of a non-conductive plastic while the studs 110 and 112 are made of a stainless steel.

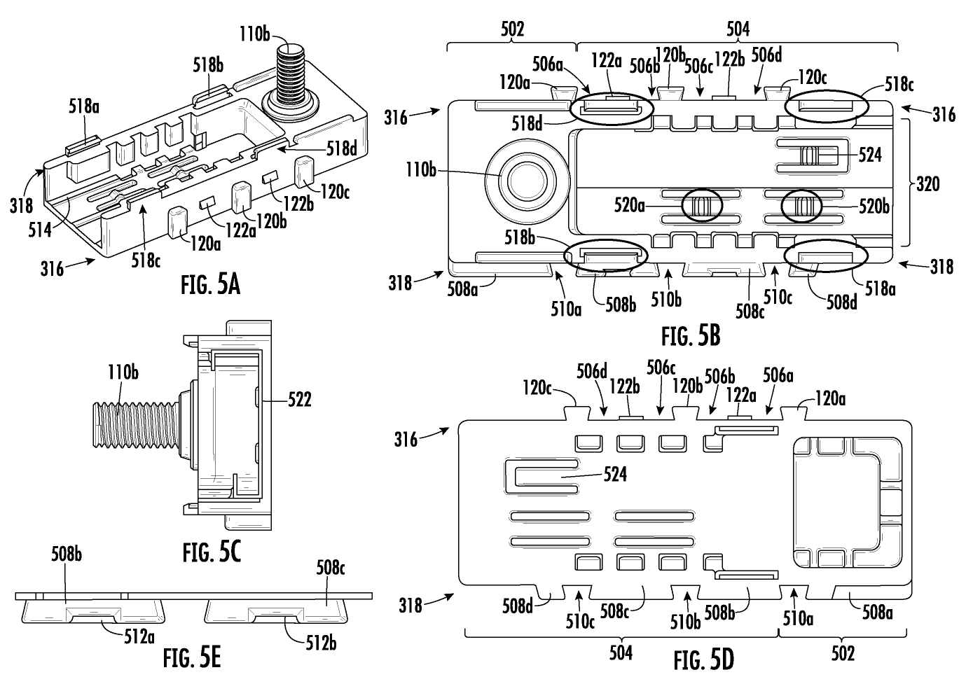

The base 104 includes a channel 320 that is sized to receive the movable tab 108. Disposed between the side 316 and the side 318, the channel 320 includes several features that enable the movable tab 108 to be secured within the base. These features are described in more detail in FIGS. 4A-4D and FIGS. 5A-5D, below.

FIGS. 4A-4E are representative drawings of the base 104a of the fuse holder 100A, according to exemplary embodiments. FIG. 4A is a perspective view, FIG. 4B is an overhead view, FIG. 4C is a side view, and FIG. 4D is a bottom view of the base 104a, while FIG. 4E is a close-up view of one edge of the base 104a with the dovetail connectors. The base 104a has a fixed stud end 402 and a movable tab region 404 as well as sides 316 and 318. In exemplary embodiments, the stud 110a is an M6 stud. The movable tab region 404 includes the channel 320 for receiving the movable tab 108 and includes several features for ensuring that the movable tab is fixed in place once its position is determined. The position of the movable tab 108 within the channel 320 is determined by the length of the fuse 106 and, more specifically, by the distance between stud apertures 208 and 210 of the fuse terminals 204 and 206, respectively.

Dovetail connectors 120a-c and lock ramps 122a-b are shown on side 316 in FIGS. 4A, 4B, and 4D. As shown in FIG. 3, these dovetail connectors 120 and lock ramps 122 may be used to connect the base 104a to the mounting tab 114. Further, the dovetail connectors 120 and lock ramps 122 are used to connect the base 104a to a second and/or third base, such that the fuse holder 100A may be stacked with one or two additional fuse holders, such as a fuse holder being on either side of the fuse holder 100A.

Between the dovetail connectors 120 and lock ramps 122 are dovetail openings 406a-d (collectively, “dovetail opening(s) 406”), located on side 316 of the base 104a. Dovetail opening 406a is between dovetail connector 120a and lock ramp 122a; dovetail opening 406b is between lock ramp 122a and dovetail connector 120b; dovetail opening 406c is between dovetail connector 120b and lock ramp 122b; and dovetail opening 406d is between lock ramp 122b and dovetail connector 120c.

On side 318 of the base 104a are differently shaped dovetail connectors as well as dovetail openings. Dovetail connector 408a is on the fixed stud end of the base 104a; in the movable tab region 404 are dovetail connectors 408b, 408c, and 408d (collectively, “dovetail connector(s) 408”). Dovetail openings 410a-c are also shown, with dovetail opening 410a being between dovetail connectors 408a and 408b, dovetail opening 410b being between dovetail connectors 408b and 408c, and dovetail opening 410c being between dovetail connector 408c and 408d (collectively, “dovetail opening(s) 410”). In exemplary embodiments, the dovetail openings 410 have a predefined shape that is similar to that of the dovetail connectors 120 on the other side of the base 104a. Further, in exemplary embodiments, the distance between dovetail openings 410a and 410b is the same as the distance between dovetail connector 120a and 120b; similarly, the distance between dovetail opening 410b and 410c is the same as the distance between dovetail connector 120b and 120c.

The dovetail connectors 120 are thus able to “fit” into the dovetail openings 410. This symmetry enables the base of second and/or third fuse holders to be connected to the base of the fuse holder 100. Thus, dovetail opening 410a is shaped to receive dovetail connector 120a of a second fuse holder base, dovetail opening 410b is shaped to receive dovetail connector 120b of the second fuse holder base, and dovetail opening 410c is shaped to receive dovetail connector 120c of the second fuse holder base. Alternatively, the dovetail connector 120a is shaped to receive dovetail opening 410a of a third fuse holder, the dovetail connector 120b is shaped to receive dovetail opening 410b of the third fuse holder, and the dovetail connector 120c is shaped to receive dovetail opening 410c of the third fuse holder.

Although differently shaped from the dovetail connectors 120, dovetail connector 408b is similarly shaped to dovetail connector 408c. Further, dovetail connector 408b is shaped like the combination of opening 406a, lock ramp 122a, and opening 406b while dovetail connector 408c is shaped like the combination of opening 406c, lock ramp 122b, and opening 406d. Further, as shown in FIG. 4E, dovetail connectors 408b and 408c include lock ramp receivers 412a and 412b, respectively (collectively, “lock ramp receiver(s) 412”). When connecting a different base to the base 104a, the lock ramp 122a fits into lock ramp receiver 412a of dovetail connector 408b while lock ramp 122b fits into lock ramp receiver 412b of dovetail connector 408c.

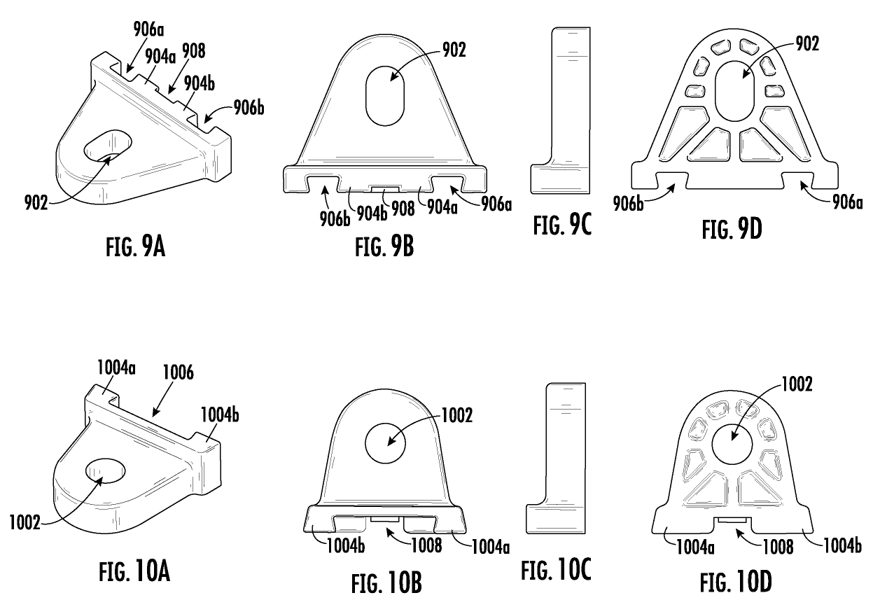

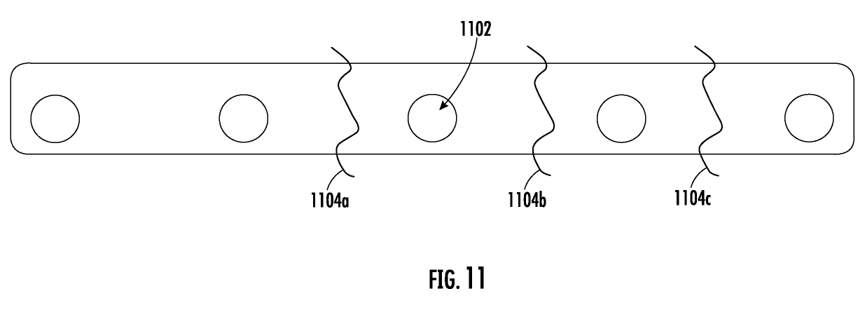

The configuration of the sides 316 and 318 of the base 104a may also be used to connect the optional mounting tabs 114 and 302, respectively. The mounting tabs are more fully described in FIGS. 9A-9D and 10A-10D, below. In exemplary embodiments, each mounting tab can assume one of two positions along its respective side of the base 104a. Thus, mounting tab 114 can be placed in one of two positions on side 316 of base 104a while mounting tab 302 can be placed in one of two positions on side 318 of base 104a. This flexibility allows the mounting tabs 114 and 302 to be offset relative to one another, which may be beneficial in limited-space environments. The stacked fuse holder configurations of FIGS. 12B-12E, below, show the mounting tabs 114 offset relative to the mounting tabs 302.

The channel 320 within the movable tab region 404 includes several elements that facilitate coupling of the movable tab 108a (with the movable stud 112a thereon) with the base 104a. A keying guide 414 provides a position indication for insertion of the movable tab 108a. The keying guide 414 is shown on the side 318 of the base 104a, and there is a second keying guide (not shown) on the side 316 of the base as well. There are opposing “gaps” between the top and bottom of the slide area to allow the keying guide 414 to be tooled for molding.

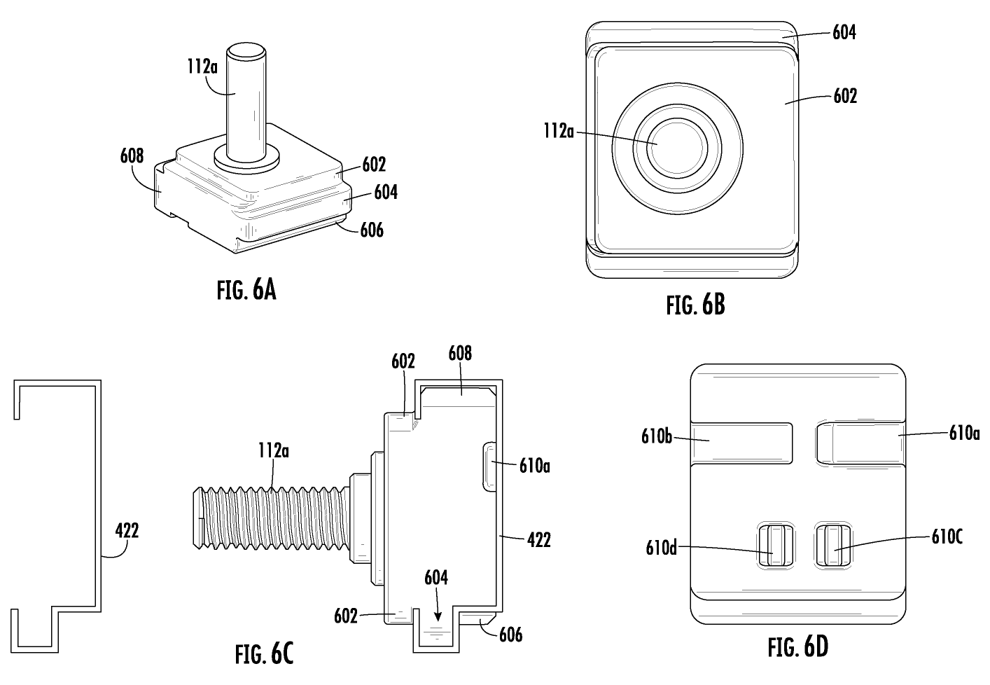

Cover lock receivers 418a-d are shown in FIG. 4B (collectively, “cover lock receiver(s) 418”) are used to affix the cover 102 to the base 104a. Bumps 420a-b are shown for securing the movable tab 108a to the base 104a (collectively, “bump(s) 420”). The bumps 420 enable the movable tab 108a to be in one of four different positions within the channel 320 of the base 104a, as explained in conjunction with the description of FIGS. 6C and 6D, below. A lock arm 424 bends downward and upward relative to the plane of the base 104a to facilitate controlling the position the movable tab 108a within the channel 320. The lock arm 424 thus flexes and locks in the movable tab 108a when inserted into the movable tab region 404 of the base 104a.

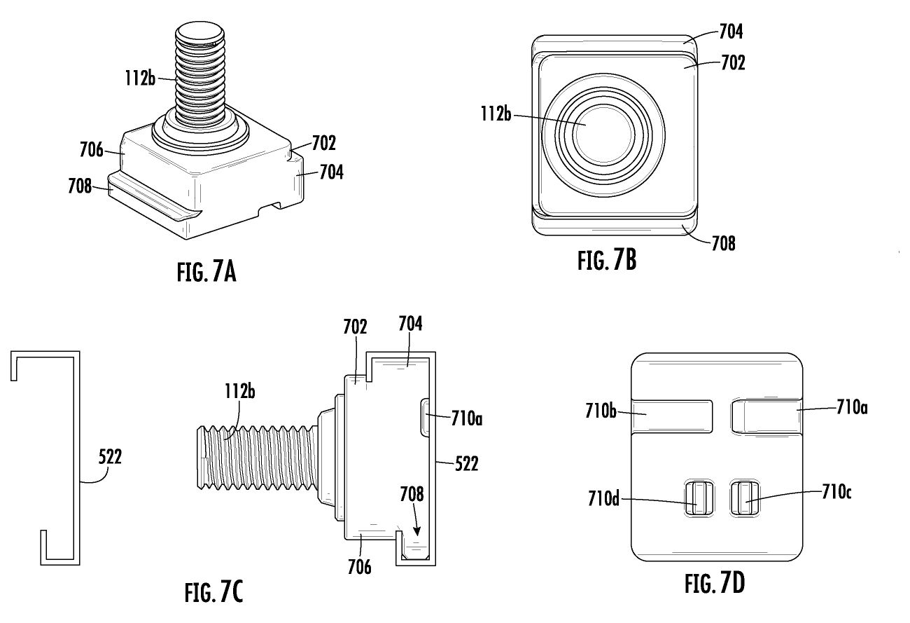

An outline (in white) 422 in FIG. 4C indicate a “poka-yoke” region of the base 104a. Poka-yoke is a “mistake-avoidance” design concept. The poka-yoke outline 422 shows the shape of movable tab that will fit into the channel 320 of the base 104a. The poka-yoke outline 422 indicates that, by design, the base 104a will accept movable tab 108a (FIG. 6C) but not movable tab 108b (FIG. 7C), due to the shape limitation caused by the poka-yoke outline 422. The poka-yoke outline 422 of the base 104a ensures that the movable tab 108a (which has an M6 stud) is inserted into the movable tab region 404 (rather than the movable tab 108b, which has an M8 stud). The poka-yoke outline 422 thus ensures correct pairing of the M6 stud (since the base 104a already has an M6 stud in its fixed stud end 402).

FIGS. 5A-5E are representative drawings of the base 104b of the fuse holder 100B, according to exemplary embodiments. FIG. 5A is a perspective view, FIG. 5B is an overhead view, FIG. 5C is a side view, and FIG. 5D is a bottom view of the base 104b, while FIG. 5E is a close-up view of one edge of the base 104b with the dovetail connectors. The base 104b has a fixed stud end 502 and a movable tab region 504 as well as sides 316 and 318. In exemplary embodiments, the stud 110b is an M8 stud. The movable tab region 504 includes the channel 320 for receiving the movable tab 108 and includes several features for ensuring that the movable tab is fixed in place once its position is determined. The position of the movable tab 108 within the channel 320 is determined by the length of the fuse 106 and, more specifically, by the distance between stud apertures 208 and 210 of the fuse terminals 204 and 206, respectively.

Dovetail connectors 120a-c and lock ramps 122a-b are shown on side 316 in FIGS. 5A, 5B, and 5D. As shown in FIG. 3, these dovetail connectors 120 and lock ramps 122 may be used to connect the base 104b to the mounting tab 114. Further, the dovetail connectors 120 and lock ramps 122 are used to connect the base 104b to a second and/or third base, such that the fuse holder 100B may be stacked with one or two additional fuse holders, such as a fuse holder on either side of the fuse holder 100B.

Between the dovetail connectors 120 and lock ramps 122 are dovetail openings 506a-d (collectively, “dovetail opening(s) 506”), located on side 316 of the base 104b. Dovetail opening 506a is between dovetail connector 120a and lock ramp 122a; dovetail opening 506b is between lock ramp 122a and dovetail connector 120b; dovetail opening 506c is between dovetail connector 120b and lock ramp 122b; and dovetail opening 506d is between lock ramp 122b and dovetail connector 120c.

On side 318 of the base 104b are differently shaped dovetail connectors as well as dovetail openings. Dovetail connector 508a is on the fixed stud end of the base 104b; in the movable tab region 504 are dovetail connectors 508b, 508c, and 508d (collectively, “dovetail connector(s) 508”). Dovetail openings 510a-c are also shown, with dovetail opening 510a being between dovetail connectors 508a and 508b, dovetail opening 510b being between dovetail connectors 508b and 508c, and dovetail opening 510c being between dovetail connector 508c and 508d (collectively, “dovetail opening(s) 510”). In exemplary embodiments, the dovetail openings 510 are shaped like the dovetail connectors 120 on the other side of the base 104b. Further, in exemplary embodiments, the distance between dovetail openings 510a and 510b is the same as the distance between dovetail connector 120a and 120b; similarly, the distance between dovetail opening 510b and 510c is the same as the distance between dovetail connector 120b and 120c.

The dovetail connectors 120 are thus able to “fit” into the dovetail openings 510. This symmetry enables the base of second and/or third fuse holders to be connected to the base of the fuse holder 100. Thus, dovetail opening 510a is shaped to receive dovetail connector 120a of a second fuse holder base, dovetail opening 510b is shaped to receive dovetail connector 120b of the second fuse holder base, and dovetail opening 510c is shaped to receive dovetail connector 120c of the second fuse holder base. Alternatively, the dovetail connector 120a is shaped to receive dovetail opening 510a of a third fuse holder, the dovetail connector 120b is shaped to receive dovetail opening 510b of the third fuse holder, and the dovetail connector 120c is shaped to receive dovetail opening 510c of the third fuse holder.

Although differently shaped from the dovetail connectors 120, dovetail connector 508b is similarly shaped to dovetail connector 508c. Further, dovetail connector 508b is shaped like the combination of opening 506a, lock ramp 122a, and opening 506b while dovetail connector 508c is shaped like the combination of opening 506c, lock ramp 122b, and opening 506d. Further, as shown in FIG. 5E, dovetail connectors 508b and 508c include lock ramp receivers 512a and 512b, respectively (collectively, “lock ramp receiver(s) 512”). When connecting a different base to the base 104b, the lock ramp 122a fits into lock ramp receiver 512a of dovetail connector 508b while lock ramp 122b fits into lock ramp receiver 512b of dovetail connector 508c.

Further, in exemplary embodiments, dovetail connectors 408 (FIGS. 4A and 4D) are identical to dovetail connectors 508 (FIGS. 5A and 5D), dovetail openings 406 are identical to dovetail connectors 506, and dovetail openings 410 are identical to dovetail openings 510. This means that fuse holder 100A (which has M6 studs 110a and 112a) can be stacked with fuse holder 100B (which has M8 studs 110b and 112b).

The configuration of sides 316 and 318 of the base 104b may also be used to connect the optional mounting tabs 114 and 302, respectively. The mounting tabs are more fully described in FIGS. 9A-9D and 10A-10D, below. In exemplary embodiments, each mounting tab can assume one of two positions along its respective side of the base 104b. Thus, mounting tab 114 can be placed in one of two positions on side 316 of base 104b while mounting tab 302 can be placed in one of two positions on side 318 of base 104b. This flexibility allows the mounting tabs 114 and 302 to be offset relative to one another, which may be beneficial in limited-space environments. The stacked fuse holder configurations of FIGS. 12B-12E, below, show the mounting tabs 114 offset relative to the mounting tabs 302.

The channel 320 within the movable tab region 504 includes several elements that facilitate coupling of the movable tab 108b (with the movable stud 112b thereon) with the base 104b. A keying guide 514 provides a position indication for insertion of the movable tab 108b. The keying guide 514 is shown on the side 318 of the base 104b, and there is a second keying guide (not shown) on the side 316 of the base as well. There are opposing “gaps” between the top and bottom of the slide area to allow the slide to be tooled for molding.

Cover lock receivers 518a-d are shown in FIGS. 5B and 5D (collectively, “cover lock receiver(s) 518”) are used to affix the cover 102 to the base 104b. Bumps 520a-b are shown for securing the movable tab 108b to the base 104b (collectively, “bump(s) 520”). The bumps 520 enable the movable tab 108b to be in one of four different positions within the channel 320 of the base 104b, as explained in conjunction with the description of FIGS. 7C and 7D, below. A lock arm 524 bends downward and upward relative to the plane of the base 104b to facilitate controlling the position the movable tab 108b within the channel 320. The lock arm 524 thus flexes and locks in the movable tab 108b when inserted into the movable tab region 504 of the base 104b.

Outline (in white) 522 in FIG. 5C indicates a “poka-yoke” region of the base 104b. The poka-yoke outline 522 shows the shape of movable tab that will fit into the channel 320 of the base 104b. The poka-yoke outline 522 indicates that, by design, the base 104b will accept movable tab 108b (FIG. 7C) but not movable tab 108a (FIG. 6C), due to the shape limitation caused by the poka-yoke outline 522. The poka-yoke outline 522 of the base 104b ensures that the movable tab 108b (which has an M8 stud) is inserted into the movable tab region 504 (rather than the movable tab 108a, which has an M6 stud). The poka-yoke outline 522 thus ensures correct pairing of M8 studs (since the base 104b already has an M8 stud in its fixed stud end 502).

FIGS. 6A-6D are representative drawings of the movable tab 108a for the fuse holder 100A, according to exemplary embodiments. FIG. 6A is a perspective view, FIG. 6B is an overhead view, FIG. 6C is a side view, and FIG. 6D is a bottom view of the movable tab 108a. In exemplary embodiments, the movable stud 112a is an M6 stud. On one side, the movable tab 108a includes an upper level 602, a middle level 604, and a lower level 606, while, on the other side, the movable tab 108a includes the upper level 602 and a bottom level 608, with the movable stud 112a emerging from the upper level 602.

In the side view of FIG. 6C, the middle level 604 is shown as protruding outward, relative to the upper level 602 and the lower level 606. The poka-yoke outline 422 (introduced in FIG. 4C) is the shape of the base 104a and is superimposed over the movable tab 108a (and is also shown isolated to the left of FIG. 6C). The movable tab 108a having the arrangement of levels 602, 604, and 606 on one side and levels 602 and 608 on the other side as shown conforms to the shape of the poka-yoke outline 422. Thus, the movable tab 108a can be inserted into the base 104a, while the movable tab 108b, which has a different arrangement of levels (FIG. 7C), would not be insertable into the base 104a.

An indentation 610a is shown on one side of the movable tab 108a (FIG. 6C) and indentations 610a-d (collectively, “indentation(s) 610”) are shown on the bottom of the movable tab 108a (FIG. 6D). The indentations 610 are used to help secure the movable tab 108a inside the base 104a of fuse holder 100A. As the movable tab 108a is slid into the base 104a of the fuse holder 100A, bump 420a of the base (FIG. 4B) may fit into indentation 610c or 610d, or bump 420b may fit into indentation 610c or 610d. This means that the movable tab 108a may be in up to four different positions within the channel 320 of the base 104a. Meanwhile, lock arm 424 flexes during movement of movable tab 108a and is positioned over indentation 610b or indentation 610a. Once seated in the desired channel 320 location, the lock arm 424 flexes back, preventing the movable tab 108a from falling out of the channel 320. Further, the indentation 610a is a material saver that helps to reduce the engagement force with the lock arm 424. Thus, the indentations 610 of the movable tab 108a, along with the bumps 420 and lock arm 424 of the base 102a, ensure that the movable tab is secured inside the base.

In FIG. 6B, the movable stud 112a is shown off-centered. Further, although the movable stud 112a is one diameter, the base portion of the movable stud is a larger diameter. In exemplary embodiments, the off-center position of the movable stud 112a as well as the inclusion of a larger-diameter base portion allows a single busbar to be used with the movable tab 108a as well as the movable tab 108b (FIGS. 7A-7D).

FIGS. 7A-7D are representative drawings of the movable tab 108b for the fuse holder 100B, according to exemplary embodiments. FIG. 7A is a perspective view, FIG. 7B is an overhead view, FIG. 7C is a side view, and FIG. 7D is a bottom view of the movable tab 108b. In exemplary embodiments, the movable stud 112b is an M8 stud. On one side, the movable tab 108b includes an upper level 702 and a lower level 704, while, on the other side, the upper level 702 has a long side 706 and there is a second lower level 708, with the movable stud 112b emerging from the upper level 702.

In the side view of FIG. 7C, the differences between the two sides of the movable tab 108b are evident. The upper level 702 is shorter on one side, while the lower level 704 is taller than the lower level 708. The poka-yoke outline 522 (introduced in FIG. 5C) is the shape of the base 104b and is superimposed over the movable tab 108b (and is also shown isolated to the left of FIG. 7C). The movable tab 108b having the arrangement of levels 702 and 704 on one side and levels 706 and 708 on the other side as shown conforms to the shape of the poka-yoke outline 522. Thus, the movable tab 108b can be inserted into the base 104b, while the movable tab 108a, which has a different arrangement of levels (FIG. 6C), would not be insertable into the base 104b.

An indentation 710a is shown on one side of the movable tab 108b (FIG. 7C) and indentations 710a-d (collectively, “indentation(s) 710”) are also shown on the bottom of the movable tab 108b (FIG. 7D). The indentations 710 are used to help secure the movable tab 108b inside the base 104b of fuse holder 100B. As the movable tab 108b is slid into the base 104b of the fuse holder 100B, bump 520a of the base (FIG. 5B) may fit into indentation 710c or 710d, or bump 520b may fit into indentation 710c or 710d. This means that the movable tab 108b may be in up to four different positions within the channel 320 of the base 104b. Meanwhile, lock arm 524 flexes during movement of movable tab 108b and is positioned over indentation 710b or indentation 710a. Once seated in the desired channel 320 location, the lock arm 524 flexes back, preventing the movable tab 108b from falling out of the channel 320. Further, the indentation 710a is a material saver that helps to reduce the engagement force with the lock arm 424. Thus, the indentations 710 of the movable tab 108b, along with the bumps 520 and lock arm 524 of the base 102b, ensure that the movable tab is secured inside the base.

In FIG. 7B, the movable stud 112b is shown off-centered. Further, although the movable stud 112b is one diameter, the base portion of the movable stud is a larger diameter. In exemplary embodiments, the off-center position of the movable stud 112b as well as the inclusion of a larger-diameter base portion allows a single busbar to be used with the movable tab 108b as well as the movable tab 108a (FIGS. 6A-6D).

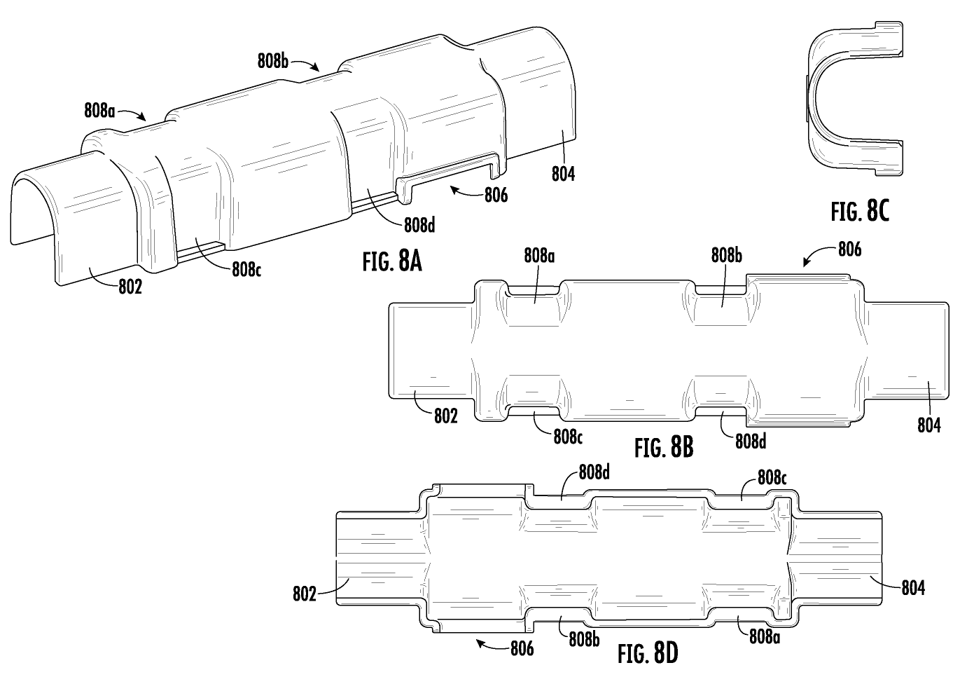

FIGS. 8A-8D are representative drawings of the cover 102 of the fuse holder 100A or the fuse holder 100B, according to exemplary embodiments. FIG. 8A is a perspective view, FIG. 8B is an overhead view, FIG. 8C is a side view, and FIG. 8D is a bottom view of the cover 102. The cover 102 is shaped to accommodate a variety of cable sizes. The cover 102 includes a first end 802 at one end of the cover, from which a cable may optionally be disposed, and a second end 804 at the other end of the cover, from which a second cable may optionally be disposed. The cover 102 also includes a busbar opening 806 through which a busbar may be disposed. Four base lock receivers 808a-d (collectively, “base lock receiver(s) 808”) are shown. The base lock receivers 808 are shaped for engaging with cover lock receivers 418 of the base 104a (FIG. 4B) or with cover lock receivers 518 of the base 104b (FIG. 5B), thus securing the cover 102 to the base.

FIGS. 9A-9D are representative drawings of the mounting tab 114 used to secure the fuse holder 100A or 100B, according to exemplary embodiments. FIG. 9A is a perspective view, FIG. 9B is an overhead view, FIG. 9C is a side view, and FIG. 9D is a bottom view of the mounting tab 114. The mounting tab 114 includes an aperture 902 through which a bolt, stud, or nail is driven, for mounting the fuse holder 100 to a surface.

Recall from FIG. 3 that mounting tab 114 is to be connected to side 316 of the base 104. Thus, the mounting tab 114 includes dovetail connectors 904a-b, dovetail openings 906a-b, and a lock ramp receiver 908 (collectively, “dovetail connector(s) 904” and “dovetail opening(s) 906”). Dovetail opening 906a will fit into dovetail connector 120a (FIG. 4B), dovetail opening 906b will fit into dovetail connector 120b, and lock ramp 122a will fit into lock ramp receiver 908. Alternatively, dovetail opening 906a will fit into dovetail connector 120b, dovetail opening 906b will fit into dovetail connector 120c, and lock ramp 122b will fit into lock ramp receiver 908. These couplings are possible for the base 104a (FIGS. 4A-4E) or for the base 104b (FIGS. 5A-5E). There are thus two different positions for the mounting tab 114 to be connected to the side 316 of the base 104.

FIGS. 10A-10D are representative drawings of the mounting tab 302 used to secure the fuse holder 100A or 100B, according to exemplary embodiments. FIG. 10A is a perspective view, FIG. 10B is an overhead view, FIG. 10C is a side view, and FIG. 10D is a bottom view of the mounting tab 302. The mounting tab 302 includes an aperture 1002 through which a bolt, stud, or nail is driven, for mounting the fuse holder 100 to a surface.

Mounting tab 302 includes dovetail connectors 1004a-b and dovetail opening 1006 (collectively, “dovetail connector(s) 1004”). A lock ramp 1008 is disposed between dovetail connector 1004a and 1004b.

Dovetail connector 1004a will fit into dovetail opening 410a (FIG. 4C) or dovetail opening 510a (FIG. 5C) while dovetail connector 1004b fits into dovetail opening 410b or dovetail opening 510b. In this configuration, lock ramp 1008 fits into lock ramp receiver 512a. Alternatively, dovetail connector 1004a will fit into dovetail opening 410b or dovetail opening 510b while dovetail connector 1004b fits into dovetail opening 410c or dovetail opening 510c. In this configuration, lock ramp 1008 fits into lock ramp receiver 512b. Thus, whether connected to base 104a or base 104b, there are two possible positions for securing the mounting tab 302 along the side 318.

FIG. 11 is a representative drawing of a busbar 1100 to be used with the fuse holder 100, according to exemplary embodiments. Specifically, the busbar 1100 is to be used when the fuse holder 100 is to be stacked with other fuse holders, as illustrated variously in FIGS. 12A-12E. The busbar 1100 includes multiple apertures 1102. Cut locations 1104a-c are shown, as the busbar may have two apertures 1102, three apertures, four apertures, or five apertures, depending on the combination of stacked fuse holders 100.

FIGS. 12A-12E are representative drawings of the fuse holder 100 shown in various stacked configurations, according to exemplary embodiments. FIG. 12A shows unstacked fuse holder 100C, FIG. 12B shows three stacked fuse holders 100D, 100E, and 100F, FIG. 12C shows three stacked fuse holders 100G, 100H, and 100I, FIG. 12D shows three stacked fuse holders 100J, 100K, and 100L, and FIG. 12E shows five stacked fuse holders 100M, 100N, 100O, 100P, and 100Q. The illustrations show the versatility of the fuse holder 100 for customers having one or more bolt-down fuses.

The fuse holder 100C (FIG. 12A) is not stacked with other fuse holders. Mounting tabs 114 is disposed on one side of the fuse holder 100C and mounting tab 302 is disposed on the other side of the fuse holder. Cable 116 is connected at one end of the fuse holder 100C and cable 118 is connected at the other end. Using the mounting tabs 114 and 302, the fuse holder 100C may be secured to a surface.

The fuse holders 100D, 100E, and 100F form a stacked assembly of fuses (FIG. 12B). Mounting tabs 302 and 114 are sufficient to secure the stacked assembly, even though there are three fuse holders. Busbar 1100 is disposed between fuse holder 100D, 100E, and 100F, with the busbar being bolted by a stud from each fuse holder. The studs connected to the busbar 1100 may be the fixed studs (e.g., stud 110) or the movable studs (e.g., 112). Due to the presence of the busbar 1100, there is a single cable 116 on one side of the stacked assembly (the same side as the busbar) while there are three cables 118 extending from the three fuse holders 100D, 100E, and 100F.

The fuse holders 100G, 100H, and 100I form another stacked assembly of fuses (FIG. 12C). Mounting tabs 302 and 114 are sufficient to secure the stacked assembly, even though there are three fuse holders. There is no busbar connecting between the fuse holders 100G, 100H, and 100I. Therefore, there are three cables 116 on one side of the stacked assembly and there are three cables 118 on the other side of the stacked assembly, with one of each cable extending from each fuse holder 100G, 100H, and 100I.

The fuse holders 100J, 100K, and 100L form another stacked assembly of fuses (FIG. 12D). A busbar 1100 connects between the fuse holders 100J and 100K, but not to fuse holder 100L. Therefore, a single cable 116 is connected to one side of fuse holder 100J (but could alternately be connected to one side of fuse holder 100K), and a second cable 116 is connected to the fuse holder 100L on the same side. There are three cables 118 on the other side of the stacked assembly, with one of each cable extending from each fuse holder 100J, 100K, and 100L.

Fuse holder 100J holds a first fuse type 106d, fuse holder 100K holds a second fuse type 106e, and fuse holder 100L holds a third fuse type 106f. The three fuses 106d, 106e, and 106f may be of different sizes and have different voltage ratings. The fuse holder 100 can support different types, sizes, and ratings of linear bolt-down fuses.

In FIG. 12E, the fuse holder assembly consists of five different fuse holders 100M, 100N, 100O, 100P, and 100Q. Fuse holders 100M and 100N are connected by busbar 1100a and fuse holders 100P and 100Q are connected by busbar 1100b. Fuse holder 100M has fuse type 106g; fuse holder 100N has fuse type 106h; fuse holder 100O has fuse type 106i; fuse holder 100P has fuse type 106j; and fuse holder 100Q has fuse type 106k, where 106g ≠ 106h ≠ 106i ≠ 106j ≠ 106k. In fuse holder 100M, the distance between the fixed stud and the movable stud is d 3; in fuse holder 100N, the distance between the fixed stud and the movable stud is d 4; in fuse holder 100O, the distance between the fixed stud and the movable stud is d 5; in fuse holder 100P, the distance between the fixed stud and the movable stud is d 6; and in fuse holder 100Q, the distance between the fixed stud and the movable stud is d 7, where d 3 ≠ d 4 ≠ d 5 ≠ d 6 ≠ d 7. These illustrations demonstrate that the fuse holder 100 enables a stackable design that can provide much needed versatility for the customer, whether the fuses are stacked together or assembled via an in-line connection.

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

While the present disclosure refers to certain embodiments, numerous modifications, alterations, and changes to the described embodiments are possible without departing from the sphere and scope of the present disclosure, as defined in the appended claim(s). Accordingly, it is intended that the present disclosure is not limited to the described embodiments, but that it has the full scope defined by the language of the following claims, and equivalents thereof.

1. A fuse holder assembly comprising:
a first fuse holder comprising:
a first stud to secure a first terminal of a first bolt-down fuse;
a first base upon which a second stud is affixed, the second stud to secure a second terminal of the first bolt-down fuse, the first base further comprising:
a first dovetail connector disposed on a first side of the first base;
a first dovetail opening disposed adjacent the first dovetail connector on the first side of the first base; and
a first lock ramp disposed adjacent the first dovetail opening on the first side of the first base; and
a second fuse holder comprising:
a third stud to secure a first terminal of a second bolt-down fuse; and
a second base upon which a fourth stud is affixed, the fourth stud to secure a second terminal of the second bolt-down fuse, the second base further comprising:
a second dovetail connector disposed on a second side of the second base;
a second dovetail opening disposed adjacent the second dovetail connector on the second side of the second base; and
a first lock ramp receiver disposed within the second dovetail connector.

2. The fuse holder assembly of claim 1, wherein the first side of the first base is coupled with the second side of the second base.

3. The fuse holder assembly of claim 2, wherein the first dovetail connector of the first side of the first base is coupled with the second dovetail opening of the second side of the second base.

4. The fuse holder assembly of claim 3, wherein the first dovetail opening of the first side of the first base is coupled with the second dovetail connector of the second side of the second base.

5. The fuse holder assembly of claim 4, wherein the lock ramp of the first side of the first base is coupled with the lock ramp receiver of the second side of the second base.

6. The fuse holder assembly of claim 1, the first base further comprising:
a second side of the first base disposed opposite the first side of the first base.

7. The fuse holder assembly of claim 6, wherein the second side of the first base is coupled to a mounting tab.

8. The fuse holder assembly of claim 7, the mounting tab further comprising:
a third dovetail connector;
a third dovetail opening disposed adjacent to the third dovetail connector; and
a second lock ramp receiver disposed within the third dovetail opening.

9. The fuse holder assembly of claim 6, the first base further comprising:
a third dovetail connector disposed on the second side of the first base;
a third dovetail opening disposed adjacent the third dovetail connector on the second side of the first base; and
a second lock ramp receiver disposed within the third dovetail connector.

10. The fuse holder assembly of claim 1, the second base further comprising:
a first side of the second base disposed opposite the second side of the second base.

11. The fuse holder assembly of claim 10, wherein the first side of the second base is coupled to a mounting tab.

12. The fuse holder assembly of claim 11, the mounting tab further comprising:
a third dovetail connector;
a third dovetail opening disposed adjacent to the third dovetail connector; and
a third lock ramp disposed adjacent to the third dovetail opening.

13. The fuse holder assembly of claim 10, the second base further comprising:
a third dovetail connector disposed on the first side of the second base;
a third dovetail opening disposed adjacent the third dovetail connector on the first side of the second base; and
a second lock ramp disposed adjacent the third dovetail opening on the first side of the second base.

14. The fuse holder assembly of claim 1, wherein the first bolt-down fuse is different from the second bolt-down fuse.

15. The fuse holder assembly of claim 1, further comprising:
a first moveable tab upon which the first stud is affixed.

16. The fuse holder assembly of claim 15, further comprising:
a second moveable tab upon which the third stud is affixed.

17. The fuse holder assembly of claim 1, the first base further comprising:
a second side of the first base disposed perpendicular to the first side of the first base.

18. The fuse holder assembly of claim 17, wherein the second side of the first base is coupled to a first mounting tab.

19. The fuse holder assembly of claim 18, the first base further comprising:
a third side of the first base disposed perpendicular to the first side of the first base and opposite the second side of the first base,
wherein the third side of the first base is coupled to a second mounting tab.
